(19) United States
(12) Patent Application Publication
(10) Pub. No.: US 2007/0081871 A1
(43) Pub. Date: Apr. 12, 2007

(54) Fixed reamer valve seat tool

(75) Inventor: John M. Cirino, Kirtland, OH (US)

Correspondence Address: PEARNE & GORDON LLP, 1801 EAST 9TH STREET, SUITE 1200, CLEVELAND, OH, 44114-3108, US

(73) Assignee: Master Tool Corporation, Grand River, OH (US)

(21) Appl. No.: 11/246,930

(22) Filed: Oct. 7, 2005

(51) Int. Cl. B23B 31/10

(52) U.S. Cl. 408/239 R

(57) ABSTRACT

A cutting tool assembly includes a rotatable body having a hole and cutting means. A member having a hole is engaged with the hole of the body by an interference fit. A cutting insert is located within the hole of the member and engaged with the member by an interference fit, and the cutting insert extends from the member for cutting. A method provides a cutting tool assembly.

### FIELD OF THE INVENTION

The present invention relates to cutting tools, and in particular, a cutting tool assembly capable of performing reaming operations where a reamer tool is fixed within the assembly.

### BACKGROUND OF THE INVENTION

There are a wide range of rotatable tools that are used to make various types of cuts in various types of materials. For example, there are numerous tools that are used to cut circular holes. Also, for example, there are many tools that are used to ream holes or to cut threads into holes.

Often, these rotatable tools form assemblies that include a cutting tool that may include various instruments for cutting. The cutting tool is rotated about a main axis of the tool to accomplish the cutting task. Such a main axis can be referred to as a rotational cutting axis. The cutting tool is often connected to a drive spindle, that is in-turn connected to a device for providing a motive force that causes the spindle and cutting tool to rotate. For example, the spindle may be connected directly, or indirectly through gearing means, to an electric motor. Generally, the spindle is a non-removable part of the rotatable tool assembly, while the cutting tool is a removable part.

Where the cutting tool assembly includes a reamer, it is well known to provide the spindle with a draw bar to which the reamer is attached. The draw bar provides the reamer with the ability to translate freely along a longitudinal axis of the spindle, independent from the rotation of the spindle. Generally, the longitudinal axis of the spindle is co-axial to the rotational axis of the spindle. Thus, as the spindle and cutting tool assembly rotate, the reamer is permitted to extend from the cutting head assembly for cutting, or to withdraw wholly within the cutting head assembly when cutting is not required.

As can be appreciated, however, there are a number of rotatable tools that include a reamer where it is not desirable or possible to include a draw bar. Most notably, Computer Numerical Control (CNC) machines, such as those that employ computer control of machine tools for the purpose of repeatedly manufacturing complex parts, often lack the ability to control a draw bar. Instead, the cutting tool assembly and reamer are often fixed to a spindle that is itself capable of translating the entire cutting head assembly along a longitudinal axis. As such, the reamer is wholly dependent upon the spindle for all translational motion. Thus, to ensure high precision machining, the reamer must be adequately secured to the cutting head assembly such that the rotational cutting axis of the reamer remains co-axial to the rotational axis of the spindle at all times.

One well known approach to the alignment of the reamer requires that the reamer itself be aligned relative to the spindle through a long and time-consuming process involving a multiplicity of fasteners and alignment measuring tools. For example, the reamer may be secured to the spindle through a series of set screws. Next, each set screw must be individually tightened or loosened. Finally, the alignment of the reamer is checked against the spindle using the alignment measuring tools. This process is repeated in an iterative fashion until the rotational cutting axis of the reamer tool is co-axial with rotational axis of the spindle.

This well known approach is time consuming, requires a great deal of knowledge and skill, and must be performed every time the reamer is replaced. For example, it may take over an hour to properly align the new reamer. Additionally, the user must possess a high degree of mechanical knowledge, skill, and specialized alignment equipment to perform this process. These restrictions are especially problematic and detrimental to users who replace the reamer frequently.

### SUMMARY OF THE INVENTION

The following presents a simplified summary of the invention in order to provide a basic understanding of some aspects of the invention. This summary is not an extensive overview of the invention. It is intended to identify neither key nor critical elements of the invention nor delineate the scope of the invention. Its sole purpose is to present some concepts of the invention in a simplified form as a prelude to the more detailed description that is presented later.

In accordance with an aspect, the present invention provides a cutting tool assembly that includes a rotatable body having a hole and cutting means. The assembly also includes a member having a hole, where the member is engaged with the hole of the body by an interference fit. A cutting insert is located within the hole of the member and is engaged with the member by an interference fit. The cutting insert extends from the member for cutting.

In accordance with another aspect, the present invention provides a method of providing a cutting tool assembly that includes a rotatable body having a hole and cutting means, a member having a hole, and a cutting insert. The method includes locating a cutting insert within the hole of the member, engaging the cutting insert with the member by an interference fit, and engaging the member with the hole of the body by an interference fit. The cutting insert extends from the member for cutting.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective, exploded view of an example tool assembly that incorporates an aspect of the present invention;

FIG. 2A is a side view of an example member from the tool assembly of FIG. 1;

FIG. 2B is a front view of the example member of FIG. 2A; and

FIG. 3 is a reverse-angle, sectional view of the example tool assembly of FIG. 1.

### DETAILED DESCRIPTION OF AN EXAMPLE EMBODIMENT

An example embodiment of a device that incorporates the present invention is shown in the drawings. It is to be appreciated that the shown example is not intended to be a limitation on the present invention. Specifically, the present invention can be utilized in other embodiments and even other types of devices. Such other types of devices include various types of cutting devices.

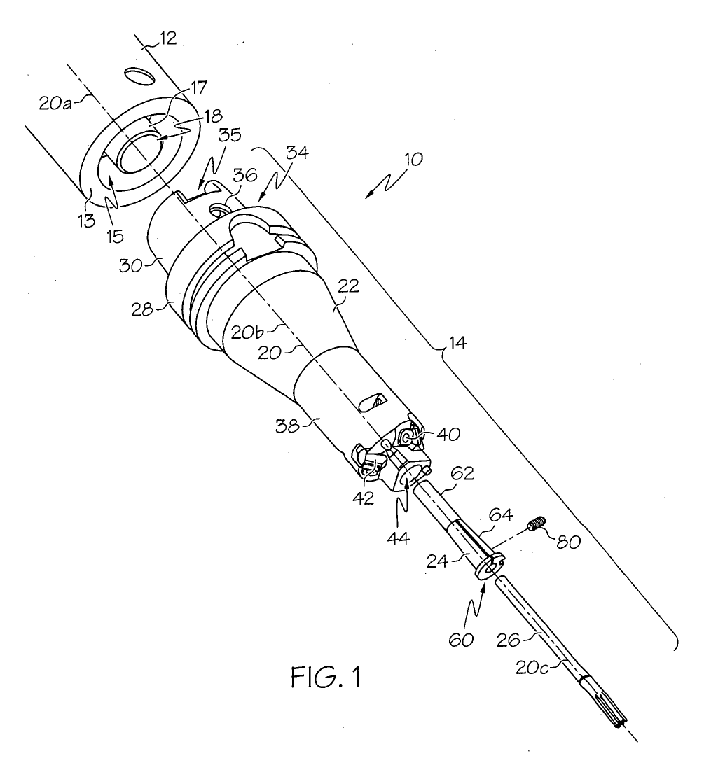

Turning to the shown example of FIG. 1, the device is a rotatable valve seat tool assembly 10 for making (e.g., via cutting) a valve seat (not shown) in an engine head (not shown). Generally, the tool assembly 10 includes a spindle 12 and a cutting head assembly 14 that extend along a longitudinal axis 20. The assembly 10 is rotatable about the longitudinal axis 20 via the spindle 12. Of course, the tool assembly 10 may take other forms, such as a tool for making something other than a valve seat, and could even be moved in a motion other than a rotational motion.

Turning back to the shown example, the spindle 12 is secured to a tooling apparatus (not shown), such as a CNC machine. The CNC machine provides a motive force to rotate the spindle about a rotational axis 20a, which is co-axial with the longitudinal axis 20. The tooling apparatus (not shown) may also provide the motive force to move the spindle in other directions, such as in a translational motion along the longitudinal axis 20. The spindle 12 also includes a mounting face 13. In the shown example, the mounting face 13 is circular in shape and forms a plane that is perpendicular to the rotational axis 20a.

The spindle 12 also includes an opening 15 through the mounting face 13 for receiving the cutting head assembly 14. The opening 15 may be of any depth, and may extend entirely through the spindle 12. The opening 15 may also include a reduced diameter portion (not shown) that creates a shoulder (not shown) adapted to receive a portion of the cutting head assembly 14.

The spindle 12 further includes attachment means 17 for attaching the cutting head assembly 14 to the spindle 12. In the shown example, the attachment means 17 has a HSK DIN-standard configuration for engaging the spindle 12 with the cutting head assembly 14. It is to be appreciated that the attachment means 17 may be of any configuration as required to securely attach the cutting head assembly 14 to any spindle 12. The attachment means 17 may further include a hole 18 extending there through. The hole 18 may be adapted to receive a portion of the cutting head assembly 14 for providing a fluid, such as coolant, thereto. It is to be appreciated that the hole 18 may be of any configuration as required by the particular cutting tool to be attached to the spindle 12. The attachment means 17 may also include additional elements as required.

With regard to the spindle 12 of the tool assembly 10, it is to be appreciated that the particulars of the spindle are not limitations on the present invention. As shown, the spindle 12, the opening 15 and the attachment means 17 are cylindrical in configuration. It is to be appreciated that the spindle 12, the opening 15, and the attachment means 17 may be of any desired configuration.

Turning now to the cutting head assembly 14, the cutting head assembly 14 includes a body 22, a member 24, and a cutting tool insert 26. In the shown example, the cutting tool insert 26 is a reamer. It is to be appreciated that the cutting head assembly 14 is not meant to be limited by this description, and may include more or less elements. In the shown example, these three elements are secured together as one assembly 14 before being secured to the spindle 12. Generally, the reamer 26 is located within the member 24. Next, member 24 and reamer 26 are secured to the body 22. Finally, the cutting head assembly 14 is secured to the spindle 12. When secured to the spindle 12, the body 22 is caused to rotate about a rotational axis 20b, which in-tum causes the reamer 26 to rotate about a rotational cutting axis 20c. In the shown example, the central axes of the body 22 and the reamer 26 are co-axial to the rotational axis 20b and the rotational cutting axis 20c, respectively.

It is to be appreciated that these elements may be secured together in any order or combination, and may or may not be secured to the spindle 12 as one assembly. For example, the member 24 and the reamer 26 may be removed and replaced without the need to also remove or replace any other elements of the cutting head assembly 14 from the spindle 12.

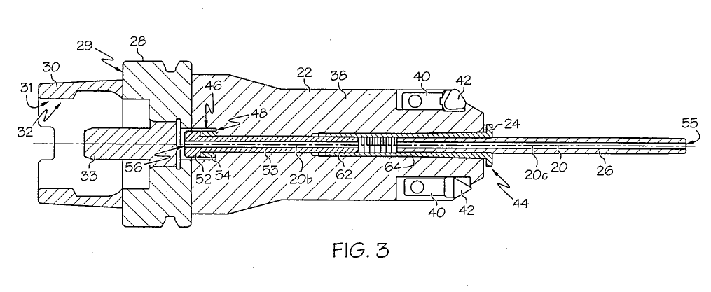

The body 22 includes an enlarged annular shoulder 28 disposed a distance from one end. The body 22 further includes a first extended portion 30 disposed on one side of the annular shoulder 28. In the shown example, the first extended portion 30 is adapted to engage with the HSK DIN-standard configuration of the attachment means 17 of the spindle 12. It is to be appreciated that the first extended portion 30 may be adapted to engage with any attachment means 17. Turning briefly to the example shown in FIG. 3, the extended portion 30 has a cylindrical configuration having a diameter less than that of the annular shoulder 28. Additionally, the extended portion 30 may taper towards one end. It is to be appreciated that the extended portion 30 may be of any configuration and, in the case of a cylindrical configuration, may have any and/or various diameters.

The first extended portion 30 may further include a hole 31 extending a distance therein. The hole 31 forms a reduced diameter region 32 within the extended portion 30 and is adapted to receive the HSK DIN-standard configuration of the attachment means 17. Additionally, a component 33 may be located within the hole 31, and is adapted to be received by the hole 18 in the attachment means 17. In the shown example, the component 33 is a coolant spigot nozzle adapted to deliver a fluid, such as a coolant, to the body 22 and/or reamer 26 of the cutting head assembly 14. It is to be appreciated that the component 33 may be adapted to deliver any fluid to any part of the cutting head assembly 14. It is also to be appreciated that the coolant may be supplied to the body 22 by alternative means (not shown). In the shown example, the hole 31 and the reduced diameter region 32 have a circular configuration, and the component 33 has a cylindrical configuration. It is to be appreciated that the shown example is not intended to be a limitation on the present invention. Specifically, the hole 31, the reduced diameter region 32 and the component 33 may be of any configuration as required by any spindle 12, or may not be included at all.

Remaining with the example shown in FIG. 3, the annular shoulder 28 and the first extended portion 30 combine to form a mounting face 29 disposed on one side of the annular shoulder 28. The mounting face 29 is adapted to abut the mounting face 13 of the spindle 12 upon attachment of the cutting head assembly 14 to the spindle 12. It is to be appreciated that the mounting face 29 may be of any configuration as required for the attachment of any body 22 to any spindle 12.

Turning back to FIG. 1, the first extended portion 30 may also contain means 34 for securing the body 22 to the spindle 12. In the shown example, the means 34 for securing includes an aperture 35 and a hole 36. The aperture 35 is disposed at one end of the extended portion 30 and comprises a channel adapted to engage with complementary structure (not shown) of the spindle 12. The hole 36 is disposed about the periphery of the second extended portion 30. A fastener (e.g., bolt, socket head cap screw, set screw, or the like, not shown) may be located with the hole 36 and is adapted to engage with complementary structure (not shown) of the spindle 12. It is to be appreciated that the body 22 may include either, or both of the aforementioned means 34 for securing, and may even include additional elements as required.

The body 22 further includes a second extended portion 38 disposed on the opposite side of the annular shoulder 28. In the shown example, the second extended portion 38 has a cylindrical configuration having various diameters along its length, all of which are less than that of the annular shoulder 28. Additionally, the extended portion 38 may taper towards one end. It is to be appreciated that the second extended portion 38 may be of any configuration and, in the case of a cylindrical configuration, may have any, and/or various diameters.

The second extended portion 38 further includes at least one cutting means 40 adapted to perform a cutting operation that is separate from that of the cutting tool insert 26. In the shown example, three cutting means 40 (the third not shown) are arranged about a periphery of the second extended portion 38. The cutting means 40 are secured to the body 22 by fasteners (not shown). It is to be appreciated that any number of cutting means 40 may be secured to the body 22 using any known method of fastening. It is also to be appreciated that the body 22 is not required to include any cutting means 40.

Turning briefly to FIG. 3, the cutting means 40 may include a cutting insert 42. In the shown example, the cutting insert 42 is triangular in shape and is exposed from the body 22 for cutting. The cutting insert 42 has at least one sharpened cutting edge that is adapted to extend radially outward from the cutting means 40 and the body 22 at a desired cutting angle. Thus, for example, upon rotation of the tool assembly 10, the cutting insert 42 engages material (e.g., the engine head) to be cut and removes portions of the material (e.g., to cut a valve seat). It is to be appreciated that the cutting insert 42 is made of a material that is sufficiently durable (e.g., metal) such that an effective (e.g., sharp) cutting edge can be readily obtained and retained for a relatively long duration.

In the shown example, the insert 42 may have multiple cutting edges, each of which can be selectively positioned for cutting. In the shown example, the insert 42 is triangular and has three cutting edges. Due to the triangular configuration of the insert 42, one selected cutting edge is positioned to perform the valve seat cutting. Once that cutting edge is worn, the insert 42 is merely rotated (e.g., 120°) to present a new sharpened edge for the cutting operation.

Turning back to FIG. 1, the extended portion 38 further includes a hole 44 that is disposed at one end and extends through the body 22. The hole 44 is sized to engage the member 24 by an interference fit. In the shown example, the hole 44 and the member 24 each have a cylindrical configuration. Thus, the diameter of the hole 44 is generally equal to or less than the diameter of the member 24 when the member is relaxed outside of the hole. However, the difference in the diameters must not be so great as to prevent an interference fit. The ratio of diameters for an interference fit will vary depending upon the specific materials that the body 22 and the member 24 are made of. It is to be appreciated that the hole 44 and the member 24 may have any configuration that provides an interference fit there between. It is to be appreciated that the interference fit may be achieved by any procedure, including, for example, press fitting or temperature differential fitting.

Turning briefly to FIG. 3, the hole 44 includes an increased diameter region 46 located within the body 22 that creates a shoulder 48. A means 52 for retaining the member 24 within the hole 44 is located therein such that a portion of the means 52 for retaining abuts the shoulder 48. In the shown example, the means 52 for retaining comprises a fastener having an externally threaded shank 53, such as a bolt or socket head cap screw. The hole 44 may include a portion that is internally threaded to engage with the threads of the fastener 52. It is to be appreciated that the fastener 52 may include other types of threaded fasteners, such screws, and may additionally include non-threaded fasteners, such as pins, shafts, and keys. A spacer 54 may be placed between the head of the fastener 52 and the shoulder 48. The fastener 52 may further include a hole 56 extending there though to permit a fluid, such as a lubricant and/or coolant, to be transferred through the body 22. In the shown example, the fastener 52 may be adapted to receive the fluid from the coolant spigot nozzle 33 and to transfer the fluid to a hole 55 in the reamer 26. It is to be appreciated that the hole 55 in the reamer 26 may extend entirely there through, or to any distance therein, and that the reamer 26 may include additional channels (not shown) for distributing the liquid to various portions of the reamer 26. It is to be also appreciated that the body 22 may include additional channels (not shown) to distribute the fluid to various portions thereof, such as, for example, the cutting means 40.

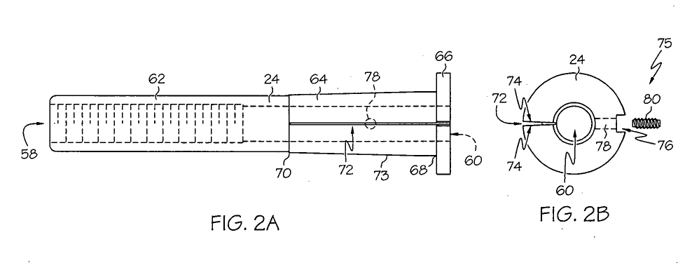

Turning now to the example shown in FIG. 2, the member 24 includes at least one hole 58 disposed at one end and adapted to be engaged with the means 52 for retaining. The member 24 may also include a separate hole 60 disposed at the opposite end for receiving the cutting tool insert 26. It is to be appreciated that the holes 58, 60 may comprise a single hole extending through the member 24, a portion of which is adapted to engage with the fastener 52, and a portion of which is adapted to receive the reamer 26. In the shown example, the hole 58 is internally threaded to engage with the threaded fastener 52. It is to be appreciated that the hole 58 may include any features for engaging any fastener 52.

In the shown example, the member 24 is a collet. As such, the example member 24 includes a first portion 62 having a generally cylindrical configuration, a second portion 64 having a cone-shaped configuration, and an annular shoulder 66 disposed at one end. The second portion 64 is disposed on one side of the annular shoulder 66 and tapers toward the first portion 62 along a shallow angle. Thus, the second portion 64 tapers from a larger first diameter 68 adjoining the annular shoulder 66 to a smaller second diameter 70 adjoining the first portion 62. The second diameter 70 of the second portion 64 is substantially equal to the diameter of the first portion 62 at the intersection of the two portions 62, 64. It is to be appreciated that the second diameter 70 may be either slightly greater than or slightly less than the diameter of the first portion 62 at the intersection of the two portions 62, 64.

A slit 72 extends through a periphery 73 of the member 24. The slit extends longitudinally from the annular shoulder 66 and along the length of the second portion 64. The slit 72 further extends through the member 24 from the periphery 73 to the hole 60. It is to be appreciated that the member 24 may include more than one slit 72, and that the slits may be disposed anywhere about the member 24.

The slit 72 is configured such that any compression of the second portion 64 will cause the distance between the edges 74 of the slit 72 to be reduced. This, in-tum, will cause the inner diameter of the hole 60 to be reduced to a corresponding extent. The inner diameter of the hole 60 will continue to be reduced until the edges 74 of the slit 72 contact each other, at which time the hole 60 will reach a minimum diameter.

It is to be appreciated that the minimum diameter of the hole 60 should be slightly less than the diameter of the reamer 26. However, the difference between the diameters must not be so great as to prevent an interference fit. The ratio of diameters for an interference fit will vary depending upon the specific materials that the member 24 and the cutting tool insert 26 are made of. In the shown example, both the hole 60 and the reamer 26 have cylindrical configurations. It is to be appreciated that the hole 60 and the reamer 26 may have any configuration that provides an interference fit there between, and that the interference fit may be achieved by any procedure, including, for example, press fitting or temperature differential fitting.

It is to be appreciated that the collet 24 is made of a resilient material, such as steel, that resists permanent deformation and is capable of returning to an original shape or position when a compressive force is removed. Thus, when the collet 24 is removed from the body 22 of the cutting head assembly 14, the distance between the edges 74 of the slit 72 will increase, returning the collet 24 to its original shape. As such, the inner diameter of the hole 60 will return to a maximum diameter when the collet 24 is in an uncompressed state.

Turning to the example shown in FIG. 2B, the collet 24 may be adapted to receive reamers 26 of various lengths. As such, the collet 24 may further include a means 75 for adjusting the distance that the reamer 26 extends from the member 24. In the shown example, at least one aperture 76 is disposed about the periphery 73. The aperture 76 extends longitudinally from the annular shoulder 66 and along the length of the second portion 64. In the shown example, the aperture 76 has a rectangular configuration and is disposed opposite the slit 72. The aperture 76 may be adapted to allow a fluid, such as a coolant, to be transferred there through. It is to be appreciated that the aperture 76 may have any configuration and be disposed anywhere about the periphery 73. It is to be further appreciated that the collet 24 is not required to include an aperture 76. The at least one aperture 76 includes at least one hole 78 extending from the aperture 76 through the collet 24. In the shown example, the hole 78 is internally threaded and adapted to receive a fastener 80, such as a set screw. In the example shown in FIG. 2A, the collet 24 includes one holes 78 located near to the center of the second portion 64. The means 75 for adjusting may further include a fastener 80, such as a set screw. Thus, the reamer 26 may be inserted into the hole 60 of the collet 24 such that the reamer 26 extends to a desired length. Next, the set screw 80 may be tightened to damp the reamer 26 to the collet 24 to retain the desired length. It is to be appreciated that the set screw 80 may be adapted to allow coolant to transfer there through.

Turning back to the example shown in FIG. 1, the cutting tool assembly 10 is assembled as shown, beginning with the reamer 26. First, the reamer is inserted into the hole 60 of the collet 24. If required, the distance that the reamer 26 extends from the collet 24 may be adjusted by using the set screws 80. Next, the first portion 62 of the collet 24 is inserted into the hole 44 of the body 22. Turning now to FIG. 3, the collet 24 is inserted into the hole 44 until the first portion 62 of the collet abuts the shank 53 of the fastener 52. Next, the fastener 52 is rotated such that the external threads of the shank 53 are caused to engage with the internal threads within the first portion 62 of the collet 24. In the shown example, because the head of the fastener 52 abuts the spacer 54, and the spacer 54 in-turn abuts the shoulder 48, the fastener 52 is restrained from any longitudinal movement. Thus, the engagement between the threads of the shank 53 and the collet 24 causes the collet 24 to be drawn further within the hole 44 of the body 22. Because the diameter of the hole 44 is less than the second diameter 70 of the second portion 64, a compressive force is created between the collet 24 and the body 22. Thus, because the second portion 64 of the collet 24 is cone-shaped, it is increasingly compressed the further it is drawn into the hole 44 to create an interference fit between the body 22 and the collet 24.

Simultaneously, the compression of the collet 24 causes the distance between the edges 74 of the slit 72 to be reduced. This, in-tum, causes the inner diameter of the hole 60 to be reduced to a corresponding extent to collapse the collet 24 about the reamer 26. Thus, because the diameter of the hole 60 in an uncompressed state was only slightly greater than the diameter of the reamer 26, any further reduction in the diameter of the hole 60 will create a compressive force between the collet 24 and the reamer 26. This compressive force thereby creates an interference fit between the collet 24 and the reamer 26.

The collet 24 will continue to be drawn into the hole 44 until the annular shoulder 66 abuts the end of the body 22. In the shown example, the hole 60 reaches its minimum diameter at substantially the same time as the annular shoulder 66 abuts the end of the body 22. It is to be appreciated that the hole 60 may reach its minimum diameter at any time while the collet 24 is being drawn into the body 22. The simultaneous interference fits between the reamer 26 and the collet 24, and the body 22 and the collet 24, act to align the rotational cutting axis 20c of the reamer 26 with the central axis 20b of the body.

Returning to the example shown in FIG. 1, the assembled cutting head assembly 14 is secured to the spindle 12 using the means 34 for securing, such that the central axis 20b of the body 22 is in co-axial alignment to the rotational axis 20a of the spindle 12. No further alignment of the reamer 26 is required. Because the central axis 20b of the body 22 is co-axial with the rotational axis 46a of the spindle 12, and the rotational cutting axis 20c of the reamer 26 is co-axial to the central axis 20b of the body 22, the rotational cutting axis 20c of the reamer 26 is automatically retained in co-axial alignment with the rotational axis 46a of the spindle 12. As such, the reamer 26 may be removed and replaced at will without the need for any further alignment procedures. For example, the cutting head assembly 14 may be quickly removed and replaced from the tool assembly 10, and upon its reattachment to the spindle 12, the rotational cutting axis 20c of the reamer 26 will be automatically retained in co-axial alignment with the rotational axis 46a of the spindle 12. Therefore, in the shown example, the rotational cutting axes of the reamer 26 and the cutting means 40 will be retained in co-axial alignment with the rotational axis 46a of the spindle 12 any time the cutting head assembly 14, or any sub-assembly or element thereof, is removed and replaced.

It is to be appreciated that the present invention includes a method of providing a cutting tool assembly. In one example, the present invention thus provides a method of providing a cutting tool assembly that includes a rotatable body having a hole and cutting means, a member having a hole, and a cutting insert. The method includes locating a cutting insert within the hole of the member, engaging the cutting insert with the member by an interference fit, and engaging the member with the hole of the body by an interference fit. The cutting insert extends from the member for cutting.

The invention has been described with reference to the example embodiment. Obviously, modifications and alterations will occur to others upon a reading and understanding of this specification. It is intended to include all such modifications and alterations insofar as they come within the scope of the appended claims or the equivalents thereof.

1. A cutting tool assembly including:
a rotatable body having a hole and cutting means;
a member having a hole, the member engaged with the hole of the body by an interference fit; and
a cutting insert located within the hole of the member and engaged with the member by an interference fit, the cutting insert extending from the member for cutting.

2. The cutting tool assembly as set forth in claim 1, wherein the member comprises a collet.

3. The cutting tool assembly as set forth in claim 2, wherein the collet includes a cone-shaped elongated portion having a shallow taper angle.

4. The cutting tool assembly as set forth in claim 1, wherein the cutting insert comprises a reamer.

5. The cutting tool assembly as set forth in claim 1, further including means for retaining the member within the hole of the body, wherein the member further includes at least one hole adapted to be engaged with the means for retaining.

6. The cutting tool assembly as set forth in claim 5, wherein the at least one hole of the member is threaded.

7. The cutting tool assembly as set forth in claim 5, wherein the means for retaining the member includes a threaded fastener.

8. The cutting tool assembly as set forth in claim 1, wherein the member includes means for adjusting the distance that the cutting insert extends from the member.

9. The cutting tool assembly as set forth in claim 8, wherein the means for adjusting includes at least one set screw.

10. The cutting tool assembly as set forth in claim 1, wherein the cutting tool assembly is capable of performing at least two separate cutting operations simultaneously.

11. The cutting tool assembly as set forth in claim 1, wherein the cutting tool assembly is rotatable.

12. A method of providing a cutting tool assembly that includes a rotatable body having a hole and cutting means, a member having a hole, and a cutting insert, the method including:
locating a cutting insert within the hole of the member;
engaging the cutting insert with the member by an interference fit, the cutting insert extending from the member for cutting; and
engaging the member with the hole of the body by an interference fit.

13. A method of providing a cutting tool assembly as set forth in claim 12, wherein the method includes providing the member as a collet.

14. A method of providing a cutting tool assembly as set forth in claim 13, wherein the collet includes a cone-shaped elongated portion having a shallow taper angle.

15. A method of providing a cutting tool assembly as set forth in claim 12, wherein the method includes providing the cutting insert as a reamer.

16. A method of providing a cutting tool assembly as set forth in claim 12, wherein the method further includes providing means for retaining the member within the hole of the body and providing at least one hole in the member adapted to be engaged with the means for retaining.

17. A method of providing a cutting tool assembly as set forth in claim 16, wherein the at least one hole of the member is threaded.

18. A method of providing a cutting tool assembly as set forth in claim 16, wherein the method further includes providing the means for retaining the member as a threaded fastener.

19. A method of providing a cutting tool assembly as set forth in claim 12, wherein the method further includes providing the member with means for adjusting the distance that the cutting insert extends from the member.

20. A method of providing a cutting tool assembly as set forth in claim 18, wherein the means for adjusting includes at least one set screw.

21. A method of providing a cutting tool assembly as set forth in claim 12, wherein the method further includes providing the assembly as a rotatable assembly.

22. A method of providing a cutting tool assembly as set forth in claim 12, wherein the method further includes performing at least two separate cutting operations simultaneously with the cutting head assembly.
